(19) United States
(12) Patent Application Publication
(10) Pub. No.: US 2009/0281781 A1
(43) Pub. Date: Nov. 12, 2009

(54) METHOD AND APPARATUS FOR GENERATING ADAPTIVE NOISE AND TIMING MODELS FOR VLSI SIGNAL INTEGRITY ANALYSIS

(75) Inventors: Ronald D. Rose, Essex Junction, VT (US); Sanjay Upreti, Lexington, KY (US)

Correspondence Address: WOOD, HERRON & EVANS, LLP (IBM-BUR), 2700 CAREW TOWER, 441 VINE STREET, CINCINNATI, OH, 45202, US

(73) Assignee: INTERNATIONAL BUSINESS MACHINES CORPORATION, Armonk, NY (US)

(21) Appl. No.: 12/115,977

(22) Filed: May 6, 2008

(51) Int. Cl. G06F 9/455

(52) U.S. Cl. 703/14

(57) ABSTRACT

A method, apparatus and program product are provided for performing a noise, timing, or other signal integrity simulation of a circuit under test. A simulation cache structure is accessed to retrieve cached simulation results for a first portion of the circuit under test. Simulation is performed on a second portion of the circuit under test to generate simulation results for the second portion. Simulation results are generated for the circuit under test by combining the simulation results for the second portion with the cached simulation results for the first portion.

### FIELD OF THE INVENTION

The present invention relates generally to computer operations and applications, and more particularly, to the design and performance analysis of VLSI chip designs.

### BACKGROUND OF THE INVENTION

Signal Integrity Analysis of large VLSI designs is an inherently time consuming process primarily because it involves a large number of accurate SPICE simulations. In general, VLSI designs contain large macros, such as with RAM arrays, which can have hundreds of thousands of individual gates. These large circuits can take excessive amounts of processing time to perform the needed simulations. For example, a particular design with a large set of macros may result in simulating millions of transistors and millions of elementary circuits or gates. Such simulations may take hundreds of hours of user time on the fastest machines currently available to designers. While this example may be on the outer edge of simulation for current technology, designers often come across VLSI circuit designs (macros) that take on the best machines available to designers' disposal and commonly require over a day's worth of run time. But as technology continues to develop, designers are finding that some macros are just too large to analyze within the capacity of the available resources. This forces the designer to switch to less accurate techniques such as grey-box/black-box methods, analysis of only the primary inputs and outputs of a circuit for characterization at a higher level of design hierarchy, or schematic-only analysis, ignoring the extracted parasitics, etc.—which in turn makes the signal integrity analysis more pessimistic for such designs.

In operation, actual components of a circuit cooperate to process electronic signals according to chip requirements. More particularly, the components interconnect to generate and communicate electronic signals. Different combinations and configurations of components affect chip performance. For example, component layout can impact chip timing. Another performance factor affected by chip design is noise. Noise is characterized as static or interference introduced as the signal travels through chip components and connections. As such, the electrical characteristics of the signal may change as it propagates through a chip. For instance, square wave characteristics of an input signal may become less distinct due to loss dispersion encountered in a chip. While some tolerance of noise is typically built into a chip design specification, unacceptable noise levels can severely impact signal clarity and chip performance. For example, data may become corrupted, e.g., a binary “1” may register as a “0.” Designs accommodating high noise levels thus run risk of pervasive error, to include unreliable results, as well as processing failure and delay.

To this end, some conventional design processes attempt to approximate chip performance using macro level analysis-reports that encapsulate or abstract critical component functionality, and that as a result, are relatively smaller in size. While the relatively smaller size of such macro level analysis can make simulation more manageable, extreme care and effort must be taken to ensure the macro level analysis possesses the resolution and fidelity necessary to accurately model the chip with meaningful accuracy. For instance, an improperly constructed macro level reports may ignore subtle, less critical components and electrical properties of a chip that can nonetheless compromise accuracy in the aggregate. As such, and despite their relatively smaller size, the generation of each macro level analysis-reports can be a painstaking, error prone and meticulous process that represents a substantial investment of manpower, memory, and processing power.

Consequently, and in part for the above delineated reasons, there exists a need for an improved manner of analyzing computer chip performance.

### SUMMARY OF THE INVENTION

Embodiments of the present invention address these and other problems associated with the prior art by providing a method, apparatus and program product for performing a noise, timing, or other signal integrity simulation of a circuit under test. The method accesses a simulation cache structure to retrieve cached simulation results for a first portion of the circuit under test. A simulation is performed on a second portion of the circuit under test to generate simulation results for the second portion. Combining the simulation results for the second portion with the cached simulation results for the first portion then generates the simulation results for the circuit under test.

In one aspect of an embodiment of the invention, the simulation results are stored for the second portion in the simulation cache structure after performing simulation on the second portion. Additionally, associated input and output setups of the second portion of the circuit under test may also be stored when storing the simulation results for the second portion of the circuit under test. Simulations may be performed utilizing a commercially available or proprietary circuit simulators.

In another aspect of an embodiment of the invention, cached simulation results may be retrieved by searching the simulation cache structure for a circuit configuration that matches the first portion of the circuit under test. In response to finding a circuit configuration that matches the first portion of the circuit under test, those cached simulation results are retrieved for the first portion of the circuit under test. In some situations the search may be narrowed by further searching the simulation cache structure for input and output setups that match the associated input and output setups of the first portion of the circuit under test. In response to finding input and output setups that match the associated input and output setups of the first portion of the circuit under test, the cached simulation results are retrieved for the first portion of the circuit under test. The input/output searching may be limited to circuit configurations that match the first portion of the circuit under test to assist in speeding up the search process.

The simulation cache structure for some embodiments may include a plurality of circuit configurations, input and output setups associated with each of the plurality of circuit configurations, and a set of simulation results for each of the plurality of circuit configurations corresponding to the input and output setups associated with each of the plurality of circuit configurations.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is an exemplary circuit diagram of a portion of a macro for analysis utilizing the methodology of the invention.

FIG. 2 is a representation of the circuit diagram of FIG. 1 decomposed into sub-circuits.

FIG. 3 is a graph from a statistical analysis of a large number of macros illustrating the number of transistors in a sub-circuit.

FIG. 4 is an exemplary hardware and software environment suitable for performing a noise simulation of a circuit under test.

FIG. 5A is a flow chart of a method for performing a simulation of a circuit under test.

FIG. 5B is a continuation of the flow chart in FIG. 5A.

FIG. 5C is a continuation of the flow chart in FIG. 5A and FIG. 5B.

### DETAILED DESCRIPTION

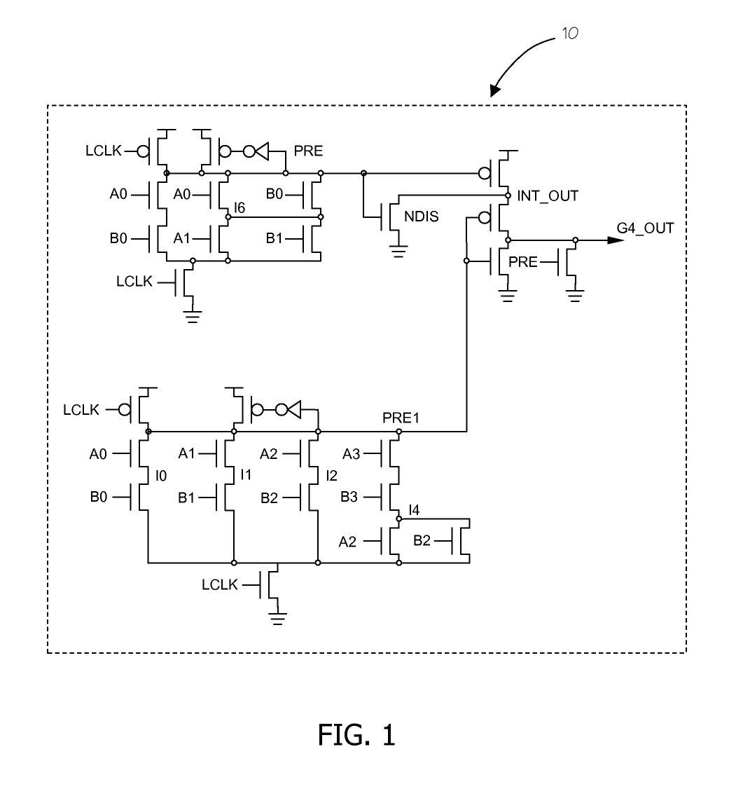

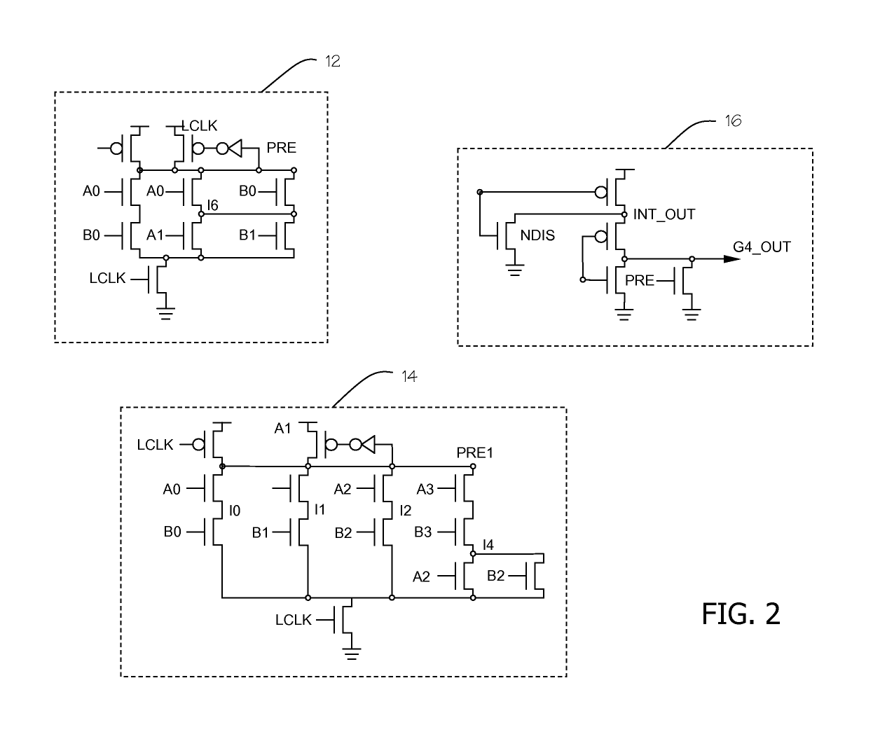

A contemporary method to perform signal integrity analysis on large designs is to break the designs into individual gates or sub-circuits. The larger design is broken into smaller portions or sub-circuits generally where devices are connected through their source/drain nodes. Analysis may then be performed on these sub-circuits with their results being combined to provide results for the entire macro. For example, FIG. 1 shows an exemplary macro 10 containing typical elements. The macro in FIG. 1 could be broken into sub-circuits 12, 14 and 16 as illustrated in FIG. 2. One method for decomposing the macro into sub-circuits is disclosed in U.S. Pat. No. 6,601,220, which is incorporated by reference herein in its entirety.

Methods for decomposing the sub-circuits into channel connected components are well known to those skilled in the art. Briefly, they involve grouping non-intersecting transistors that are connected by source and drain terminals to each other, and to supply and ground nets, such as seen in the sub-circuits 12, 14, 16 in FIG. 2 that are derived from macro 10 (FIG. 1). A circuit simulation may then be first run on the channel connected component of one of the sub-circuits 12, 14, 16. Methods for obtaining a suitable simulation generally involve performing a transient analysis of the channel connected component, and such methods are well known in the art. For example, in one embodiment, a commercially available circuit simulator, such as SPICE or proprietary simulators such as IBM's PowerSPICE, is invoked in a sub-routine fashion from a static analysis program. Alternately, the circuit simulation is performed prior to the static analysis, and the relevant data is passed to the static analyzer.

Performing the simulation requires test patterns to be applied to channel connected components. As discussed previously, for large circuits, it is impractical to fully test all possible patterns to determine the worst case delay time or noise scenarios. However, according to this methodology, it is only necessary to simulate the channel connected component, which, may for example, contain only nine transistors such as with sub-circuit 12. Because this is such a small circuit with only a few inputs, it is entirely practical to simulate all necessary patterns to determine the worst case condition of the channel connected component. Similarly, a simulation would be performed on sub-circuit 14. Sub-circuit 16 may now be simulated with a pattern which includes signals resulting from sub-circuits 12 and 14.

The number of such sub-circuits in a typical design may be very large, and in general may encompass thousands of sub-circuits, and at times tens or hundreds of thousands of sub-circuits depending on the size of the macro being analyzed. The number of devices in each of these sub-circuits is a variable and depends on the logic design. A statistical analysis was performed on a large microprocessor design and it was found that more than 90% of the time the sub-circuits consist of no more than a couple dozen transistors. These transistors form a relatively very small number of meaningful logical topologies (circuit-patterns).

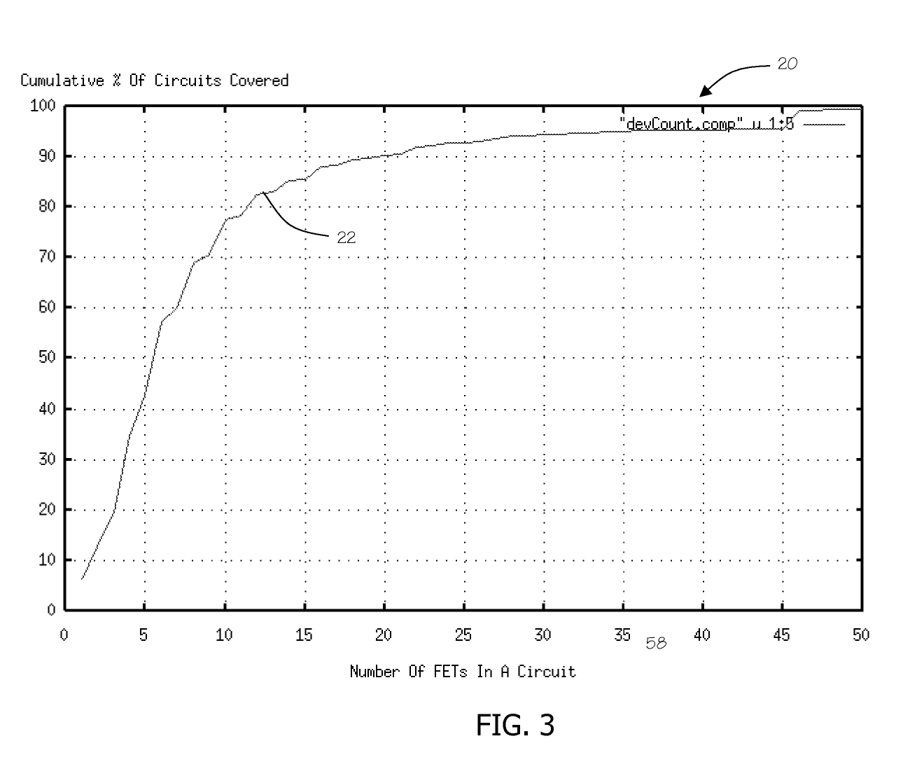

Referring to the graph 20 in FIG. 3, which shows the cumulative percentage of sub-circuits in a hypothetical nominal design that contains a given number of transistors (or FETs), it can be seen from curve 22 that approximately 78% of the sub-circuits contain ten or fewer transistors. As can also be seen from curve 22 that 90% of the sub-circuits contain twenty or fewer transistors and approximately 99% of the sub-circuits contain fifty or fewer transistors. This graph provides insight into how the sub-circuits connect at the lowest level in VLSI designs. From this, one skilled in the art can derive that the number of transistors for all but a select few sub-circuits is small. The relatively small number of transistors also means that there are a relatively small number of combinations of these transistors that could be reused in a circuit analysis. Embodiments of the invention may build a database of these circuits for different simulations and store and reuse the results for future use.

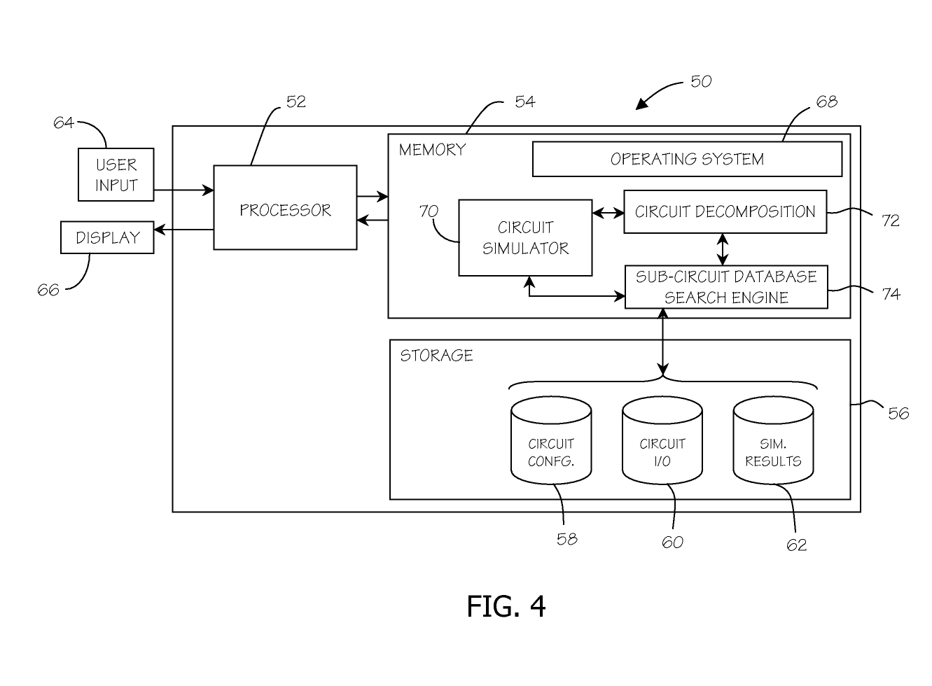

Turning now FIG. 4, which illustrates an exemplary hardware and software environment for an apparatus 50 suitable for building and accessing sub-circuit data stored in an noise simulation cache structure for reuse in VLSI circuit simulation consistent with the invention. Additionally, the actual circuit simulation may be performed on apparatus 50, or may be performed on another apparatus communicating with apparatus 50. For the purposes of the invention, apparatus 50 may represent practically any computer, computer system, or programmable device e.g., multi-user or single-user computers, desktop computers, portable computers and devices, handheld devices, network devices, mobile phones, etc. Apparatus 50 will hereinafter be referred to as a “computer” although it should be appreciated that the term “apparatus” may also include other suitable programmable electronic devices.

Computer 50 typically includes at least one processor 52 coupled to a memory 54. Processor 52 may represent one or more processors (e.g. microprocessors), and memory 54 may represent the random access memory (RAM) devices comprising the main storage of computer 50, as well as any supplemental levels of memory, e.g., cache memories, non-volatile or backup memories (e.g. programmable or flash memories), read-only memories, etc. In addition, memory 54 may be considered to include memory storage physically located elsewhere in computer 50, e.g., any cache memory in a processor 52, as well as any storage capacity used as a virtual memory, e.g., as stored on a mass storage device 56 or another computer coupled to computer 50 via a network. The mass storage device 56 may store objects, databases 58, 60, 62 forming a simulation cache structure, which may be configured to store sub-circuit configuration data, environment parameters, including inputs and outputs, for the sub-circuit configuration and simulation results for the sub-circuits.

Computer 50 also typically receives a number of inputs and outputs for communicating information externally. For interface with a user or operator, computer 50 typically includes one or more user input devices 64 (e.g., a keyboard, a mouse, a trackball, a joystick, a touchpad, a keypad, a stylus, and/or a microphone, among others). Computer 50 may also include a display 66 (e.g., a CRT monitor, an LCD display panel, and/or a speaker, among others). The interface to computer 50 may also be through an external terminal connected directly or remotely to computer 50, or through another computer communicating with computer 50 via a network, modem, or other type of communications device.

Computer 50 operates under the control of an operating system 68, and executes or otherwise relies upon various computer software applications, components, programs, objects, modules, data structures, etc. (e.g. circuit simulator 70 or circuit decomposition 72). A sub-circuit database search engine 74, for example, may be provided to copy/insert data between data stored on the database 58, 60, 62 forming the simulation cache structure, and the circuit simulator 70. Computer 50 may communicate on a network through a network interface (not shown).

In general, the routines executed to implement the embodiments of the invention, whether implemented as part of an operating system or a specific application, component, program, object, module or sequence of instructions will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in specific embodiments of the invention. However, it should be appreciated that any particular program nomenclature that follows is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 4 is not intended to limit the present invention. Indeed, those skilled in the art will recognize that other alternative hardware and/or software environments may be used without departing from the scope of the invention.

Taking advantage of the reusable potential of sub-circuits as disclosed above, embodiments of the invention quantize device parameters, input noise patterns and encode the device orders for connectivity in order to achieve a fast lookup through a multi-dimensional database of known simulation results. An advantage of doing this level of noise caching includes the multiplicity of reuse possible in a typical circuit and chip design. Analysis has shown that, within a single macro analysis, the same circuit pattern in a sub-circuit may occur multiple times, which suggests the results generated for that sub-circuit can be reused. Additionally, multiple macros may share very common lower level gates (sub-circuits) so that the cached results from the analysis of one macro can be used for another macro, which reduces the amount of time required for analyzing the second macro. This may also prove useful for macros within a microprocessor or any other chip units that tend to have the same fundamental blocks (cells) on which the macros designs are based. Further, going beyond a unit, multiple units again can share the same fundamental results to analyze their macros. Essentially, starting from the very first macro analysis, as more and more macros are analyzed, the analysis becomes faster and faster, with the cached simulations covering a larger solution space.

Because the simulation times of the smaller sub-circuits are relatively short, care should be taken in developing the database(s) in the simulation cache structure for storing the cached data. Locating and accessing the cached simulation results should require less time than the actual simulation itself, if advantages of the caching are to be realized. In one embodiment, multiple techniques are utilized to quantize and compress input waveforms data and device parameters, and have encoded device connectivity to permit fast access to the cached database. Quantization of an analog signal or a wave is the process by which a signal's amplitude is sampled using a minimum quantum step, known as resolution and thus representing the amplitude by an integer (quantum) number instead of the true value. While this process introduces a small error of measurement, the error can be minimized by proper use of resolution and can be made insignificant for a given specific application. Encoding, similar to quantizing, is a process of quantization of any data followed by compressing the bit-patterns into bytes representing a 1-byte, 2-byte, 4-byte, or 8-byte integer. Additionally, the use of tolerance on accuracy due to quantization of device parameter variations may assist in decreasing the access and retrieval times, also affecting how the cached data is stored and how quickly it can be retrieved based on matched gate patterns.

Estimates have shown that in utilizing this technique, once the cached results are built for a few macros, may significantly reduce the processing times and other resources needed for noise simulations. In addition, entire noise tolerance curves, which may be used to represent the circuit tolerance to noise to analysis tools that analyze a higher level of the design hierarchy, can further be cached for primary inputs to gates, thus avoiding hundreds of tolerance simulations per primary input per gate.

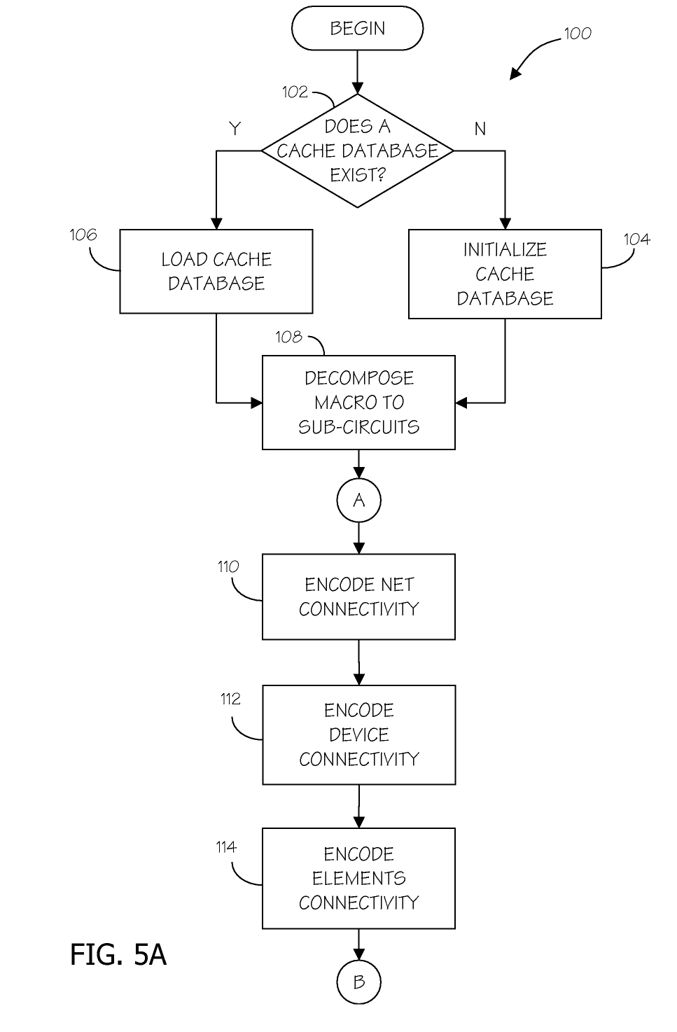

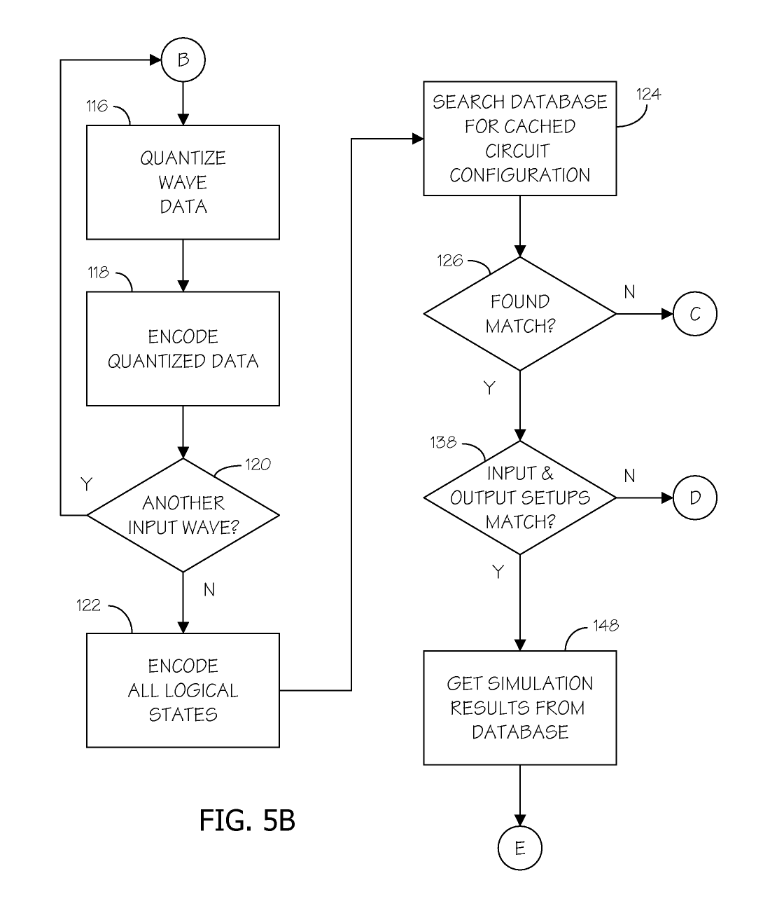

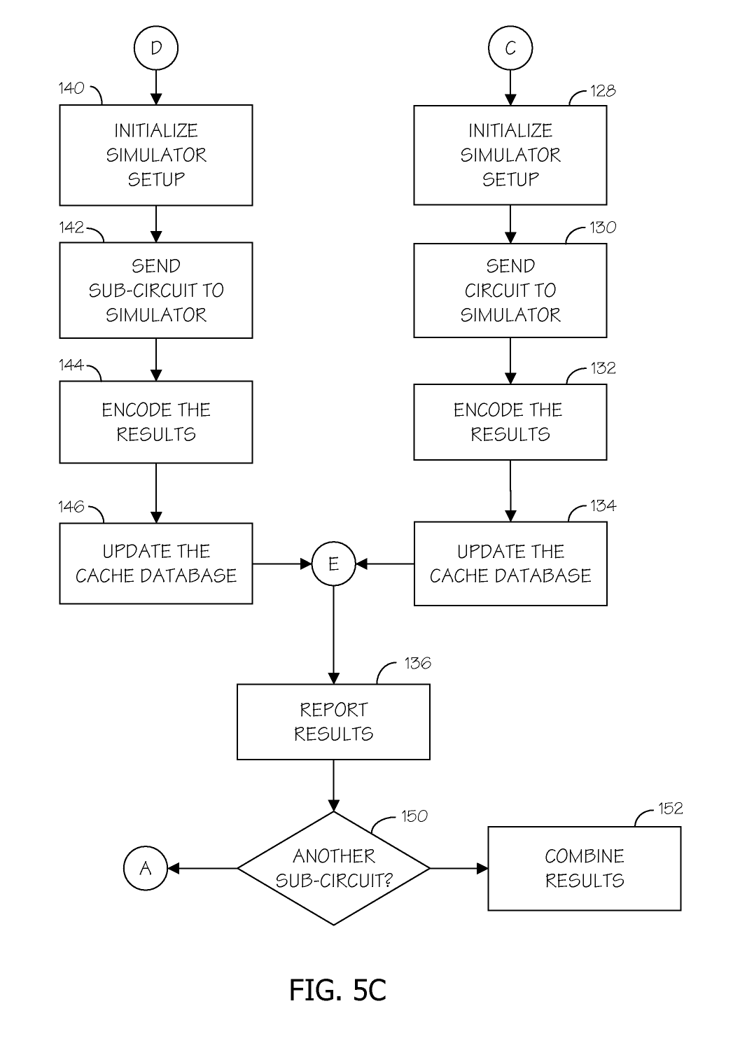

One such method to perform noise simulation for large macros is shown in the flowchart 100 of FIGS. 5A-5C. A check may be made, prior to initiating the simulation, to determine if a noise simulation cache structure, including cache database(s), exists in decision block 102. If a simulation cache structure does not exist (“No” branch of decision block 102), then a cache structure may be initialized to store circuit configurations and simulation results in block 104. If the cache structure does exist (“Yes” branch of decision block 102), then the cache structure is made available for simulation in block 106.

Simulation may begin by decomposing a circuit under test (macro) into sub-circuits using known methods as set forth above in block 108. The sub-circuit topology and connections can be defined by standard methods known in the art including net connectivity, device connectivity, and element connectivity information. This connectivity information, defining the sub-circuit topology and connections, is encoded to facilitate searching of the cache structure in blocks 110, 112, and 114. Next, waveform data associated with the sub-circuit is quantized in block 116. This quantized wave data is also encoded in block 118 to further facilitate searching the simulation cache structure for cached results. If multiple sets of wave data are present for the sub-circuit (“Yes” branch of decision block 120), the steps 116 and 118 are repeated for each set of wave data. Finally, the logical states of the sub-circuit are encoded in block 122.

The encoded information is then used to search the cache structure for the current sub-circuit configuration in block 124. If the sub-circuit configuration is not found (“No” branch of decision block 126), then the circuit simulator may be initialized in block 128 and the sub-circuit may be analyzed in block 130 as is conventionally done. After the simulation has completed, the results of the simulation are then encoded in block 132 and the cache structure is updated to include the circuit configuration and associated simulation inputs as well as the encoded results from the simulation in block 134. The results may then be reported and/or further utilized in block 136.

If the sub-circuit configuration was found (“Yes” branch of decision block 126), then a further check is performed to determine if the input and output setups for the current simulation match those previously stored in the cache structure for the sub-circuit configuration in block 138. If the input and output setups for the simulation do not match (“No” branch of decision block 138), then the circuit simulator may be initialized in block 140 and the sub-circuit may be analyzed in block 142 as is conventionally done. After the simulation has completed, the results of the simulation are then encoded in block 144 and the cache structure is updated to include the circuit configuration and associated simulation inputs as well as the encoded results from the simulation in block 146. The results may then be reported and/or further utilized in block 136.

If, however, the input and output setups do match (“Yes” branch of decision block 138), no analysis need be performed and the simulation results may be retrieved from the cache structure in block 148. These results are then reported in block 136 and a check to determine if an additional sub-circuit needs to be simulated is performed in block 150. If another sub-circuit is available to simulation (“Yes” branch of decision block 150), then the process is repeated beginning again at block 110. Otherwise, the results of simulations and retrieved results may be combined in block 152.

Using the methodology presented above, a cache of “Noise Models” may be created for every sub-circuit (as described above) with the results from simulations being stored in memory and on the disk. The methodology assists in avoiding repeated sensitivity searches, which may involve numerous simulations to determine which input conditions will lead a circuit output to change logical state, by instead storing the final value with respect to each input/output pair. Only vital statistics for input/output waves may be stored instead of the entire wave data, which may result in quantizing waveform points to 8-12 bit encoded data, for example. Having a quick search algorithm to match sub-circuit patterns to identify results in the cached database facilitates the location and retrieval of the data. The noise simulation cache structure and associated search tools may be placed between the circuit decomposition and the simulator calls where the control may be passed from the circuit decomposition to the noise simulation cache structure and associated search tools to decide when to actually send sub-circuits to a simulator and when use existing cached results.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A method of performing a noise, timing, or other signal integrity simulation of a circuit under test, the method comprising:
accessing a simulation cache structure to retrieve cached simulation results for a first portion of the circuit under test;
performing simulation on a second portion of the circuit under test to generate simulation results for the second portion; and
generating simulation results for the circuit under test by combining the simulation results for the second portion with the cached simulation results for the first portion.

2. The method of claim 1, further comprising:
after performing simulation on the second portion, storing the simulation results for the second portion of the circuit under test in the simulation cache structure.

3. The method of claim 2 further comprising:
storing a circuit configuration and associated input and output setups of the second portion of the circuit under test when storing the simulation results for the second portion of the circuit under test.

4. The method of claim 1 wherein retrieving cached simulation results comprises:
searching the simulation cache structure for a circuit configuration that matches the first portion of the circuit under test; and
in response to finding a circuit configuration that matches the first portion of the circuit under test, retrieving the cached simulation results for the first portion of the circuit under test.

5. The method of claim 4 wherein the first portion of the circuit under test includes associated input and output setups, the method further comprising:
further searching the simulation cache structure for input and output setups that match the associated input and output setups of the first portion of the circuit under test; and
in response to finding input and output setups that match the associated input and output setups of the first portion of the circuit under test, retrieving the cached simulation results for the first portion of the circuit under test,
wherein the searching is limited to circuit configurations that match the first portion of the circuit under test.

6. The method of claim 1 wherein the simulation cache structure comprises:
a plurality of circuit configurations;
input and output setups associated with each of the plurality of circuit configurations; and
a set of simulation results for each of the plurality of circuit configurations corresponding to the input and output setups associated with each of the plurality of circuit configurations.

7. The method of claim 1 wherein performing the simulation utilizes a commercially available circuit simulator.

8. An apparatus comprising:
a processor; and
program code configured to be executed by the processor for performing a noise, timing, or other signal integrity simulation of a circuit under test, the program code configured to access a simulation cache structure to retrieve cached simulation results for a first portion of the circuit under test, perform simulation on a second portion of the circuit under test to generate simulation results for the second portion, and generate simulation results for the circuit under test by combining the simulation results for the second portion with the cached simulation results for the first portion.

9. The apparatus of claim 8, wherein the program code is further configured to:
store the simulation results for the second portion in the simulation cache structure after performing simulation on the second portion.

10. The apparatus of claim 9, wherein the program code is further configured to:
store a circuit configuration and associated input and output setups of the second portion of the circuit under test when storing the simulation results for the second portion of the circuit under test.

11. The apparatus of claim 8 wherein the program code is configured to retrieve cached simulation results by:
searching the simulation cache structure for a circuit configuration that matches the first portion of the circuit under test; and
in response to finding a circuit configuration that matches the first portion of the circuit under test, retrieving the cached simulation results for the first portion of the circuit under test.

12. The apparatus of claim 11 wherein the first portion of the circuit under test includes associated input and output setups, and wherein the program codes is further configured to:
further search the simulation cache structure for input and output setups that match the associated input and output setups of the first portion of the circuit under test, and
in response to finding input and output setups that match the associated input and output setups of the first portion of the circuit under test, retrieve the cached simulation results for the first portion of the circuit under test,
wherein the search is limited to circuit configurations that match the first portion of the circuit under test.

13. The apparatus of claim 8 wherein the simulation cache structure comprises:
a plurality of circuit configurations;
input and output setups associated with each of the plurality of circuit configurations; and
a set of simulation results for each of the plurality of circuit configurations corresponding to the input and output setups associated with each of the plurality of circuit configurations.

14. The method of claim 8 wherein the program code is configured to perform the simulation using a commercially available circuit simulator.

15. A program product, comprising:
computer readable medium; and
program code resident on the computer readable medium and configured for performing a noise, timing, or other signal integrity simulation of a circuit under test, the program code further configured to access a simulation cache structure to retrieve cached simulation results for a first portion of the circuit under test, perform simulation on a second portion of the circuit under test to generate simulation results for the second portion, and generate simulation results for the circuit under test by combining the simulation results for the second portion with the cached simulation results for the first portion.

16. The program product of claim 15, wherein the program code is further configured to:
store the simulation results for the second portion in the simulation cache structure after performing simulation on the second portion.

17. The program product of claim 16, wherein the program code is further configured to:
store a circuit configuration and associated input and output setups of the second portion of the circuit under test when storing the simulation results for the second portion of the circuit under test.

18. The program product of claim 15 wherein the program code is configured to retrieve cached simulation results by:
searching the simulation cache structure for a circuit configuration that matches the first portion of the circuit under test; and
in response to finding a circuit configuration that matches the first portion of the circuit under test, retrieving the cached simulation results for the first portion of the circuit under test.

19. The program product of claim 18 wherein the first portion of the circuit under test includes associated input and output setups, and wherein the program codes is further configured to:
further search the simulation cache structure for input and output setups that match the associated input and output setups of the first portion of the circuit under test, and
in response to finding input and output setups that match the associated input and output setups of the first portion of the circuit under test, retrieve the cached simulation results for the first portion of the circuit under test,
wherein the search is limited to circuit configurations that match the first portion of the circuit under test.

20. The program product of claim 15 wherein the simulation cache structure comprises:
a plurality of circuit configurations;
input and output setups associated with each of the plurality of circuit configurations; and
a set of simulation results for each of the plurality of circuit configurations corresponding to the input and output setups associated with each of the plurality of circuit configurations.
